(19) United States
(12) Patent Application Publication
(10) Pub. No.: US 2022/0315250 A1
(43) Pub. Date: Oct. 6, 2022

(54) SPACE AIRCRAFT WITH OPTIMISED DESIGN AND ARCHITECTURE

(71) Applicant: ArianeGroup SAS, Paris (FR)

(72) Inventors: Marco PRAMPOLINI, Chambourcy (FR); Alexis BOURGOING, Suresnes (FR)

(21) Appl. No.: 17/596,133

(22) PCT Filed: Jun. 5, 2020
(86) PCT No.: PCT/FR2020/050962

§ 371 Date: Dec. 3, 2021

(30) Foreign Application Priority Data
Jun. 7, 2019 (FR) 1906098
Jun. 7, 2019 (FR) 1906101

(51) Int. Cl. B64G 1/14; B64G 1/62; B64G 1/36; B64G 1/40

(52) U.S. Cl. CPC B64G 1/14; B64G 1/62; B64G 1/36; B64G 1/402; B64G 1/401

(57) ABSTRACT

A space aircraft including a fuselage, two wings arranged on either side of the fuselage, and two nacelles arranged at the ends of the wings and each carrying a horizontal tail and a vertical tail, the fuselage having a cross section of variable size along the longitudinal axis with a maximum cross section being located in a longitudinal position located in front of the longitudinal position of the leading edges of the wings at the fuselage, making it possible in particular to help prevent the space aircraft from losing longitudinal static stability, the space aircraft thus having an optimized design and architecture which are suitable for the severe conditions encountered by such a space aircraft, in particular during atmospheric re-entry.

### TECHNICAL FIELD

The present invention relates to a space aircraft, that is, a spacecraft capable of atmospheric re-entry, that is, a return to Earth in flight, with an optimised design and architecture.

### STATE OF THE ART

Although not exclusively, the space aircraft according to the present invention may especially be a space module, that is, a craft forming part of a space launch vehicle, a sounding rocket or a similar experimental vehicle. Such a module especially comprises a propulsion assembly, and is to be recovered on Earth after the space launch vehicle, sounding rocket or similar experimental vehicle has completed its mission.

From document FR-2 961 179 it is known such a recoverable space module for a space launch vehicle. This module comprises high-cost components, whose reuse is very advantageous, such as a propulsion assembly, a pressurisation system, the avionics and electrical power generation means.

It is known that, during atmospheric re-entry, such a space craft or module is subjected to high speeds which generate, in particular, stability problems, especially via shock wave generation and boundary layer separation.

In particular, shock wave generation in the middle of the wings can cause significant flow detachment and thus generate a loss of both longitudinal and lateral stability of the aircraft.

Such a situation is unsatisfactory.

### DISCLOSURE OF THE INVENTION

The present invention relates to a space aircraft enabling the aforesaid drawbacks to be overcome, avoiding a loss of longitudinal and lateral stability. Said space aircraft is of the type comprising a fuselage and two wings arranged on either side of said fuselage, said wings being arranged so that their respective leading edges are located at a position called first longitudinal position along a longitudinal axis of said fuselage, the space aircraft also comprising two nacelles arranged at the ends of the wings, these nacelles each carrying a vertical tail unit and a horizontal tail unit.

According to the invention, said fuselage has a transverse cross-section of variable size along the longitudinal axis of said fuselage, and, from front to rear of the space aircraft, along the longitudinal axis, the size of the transverse cross-section of the fuselage increases to a maximum transverse cross-section and then decreases, and the maximum transverse cross-section is located at a position called second longitudinal position along said longitudinal axis, this second longitudinal position being located frontwardly of said first longitudinal position (corresponding to the position of the leading edges of the wings at the fuselage).

The position of the maximum transverse cross-section of the fuselage on the space aircraft approximately determines the longitudinal position of a transonic shock wave. Thus, locating the maximum transverse cross-section frontwardly of the leading edge of the wings positions the first shock wave in front of the leading edge of the wings in the transonic regime, thus avoiding or at least limiting a second shock wave in the middle of the wings. This prevents the occurrence of a significant flow detachment, as mentioned above, and thus avoids a loss of longitudinal stability of the space aircraft under these conditions.

The arrangement of tail units on the nacelles laterally with respect to the fuselage increases the moment exerted by each of the tail units about the centre of masses of the space aircraft, and thus increases the efficiency of the tail units in stabilising the space aircraft.

Moreover, the space aircraft is preferably without a central tail unit (that is, arranged on the fuselage, typically at the rear end of the latter), particularly in cases where the space aircraft has a rocket engine at the rear end of the fuselage.

As will become clearer in the following, the space aircraft design strategy adopted within the scope of the present invention, which allows an area rule to be satisfied, allows the displacement of the aerodynamic centre to be controlled throughout the Mach number range encountered by the space aircraft during a typical atmospheric re-entry.

Advantageously, rearwardly of said second longitudinal position of maximum transverse cross-section, the fuselage has an external surface shaped such that it has an angle, preferably variable, with the longitudinal axis which is less than or equal to 7°. This prevents sudden flow detachment from the fuselage rearwardly of the maximum transverse cross-section.

Furthermore, advantageously, each of said nacelles has a transverse cross-section of variable size along the longitudinal axis of said fuselage. From front to rear, along the longitudinal axis, the size of the transverse cross-section of each of said nacelles increases to a maximum transverse cross-section and then decreases, and the maximum transverse cross-section is at a position along said longitudinal axis, which is located between the trailing edge of the wing and the leading edge of the horizontal tail unit of the considered nacelle.

The above characteristics allow advantageous positioning of transonic shock waves, close to the maximum transverse cross-sections, upstream of the control surfaces of the nacelle and the main wing, which thus remain as free as possible from any shock wave disturbance in the transonic flight regime.

Furthermore, advantageously, the nacelle and wing fairings are configured to locally increase the robustness to transonic flow separation.

In one embodiment, on each of said nacelles, the vertical tail unit and the horizontal tail unit are arranged on the considered nacelle so that a maximum transverse cross-section of the vertical tail unit is located longitudinally rearwardly of a maximum transverse cross-section of the horizontal tail unit, in order to minimise interference between the control surfaces, in particular in transonic flight regimes of the space aircraft.

Besides, advantageously, the space aircraft comprises at least some of the following systems:
avionic systems and a pressurisation system arranged in the nose of the space aircraft;
aeronautical propulsion units arranged in the nacelles, frontwardly of said nacelles;
at least one rocket engine arranged rearwardly of the space aircraft; and
fuel tanks arranged in the wings of the space aircraft near the fuselage.

Preferably, the aeronautical propulsion units are arranged frontwardly of a twist line of the space aircraft wings.

Furthermore, advantageously, the spanwise positions of the nacelles are located beyond a maximum expansion profile of the exhaust gases of the rocket engine rearwardly of the space aircraft, such a maximum profile typically being obtained outside the atmosphere at the end of the propulsion phase.

Besides, advantageously, main systems of the space aircraft are separated from each other.

Furthermore, advantageously:
the fuselage is axisymmetric; and/or
the wings are positioned at mid-plane; and/or
the nacelles are arranged in a medium plane of the wings.

Furthermore, advantageously, each of said vertical tail units comprises a fixed fin and a rudder, the rudder is a split type rudder comprising two independent movable rudder flaps, the rudder is a split rudder comprising two independent movable rudder flaps, each of said rudder flaps being individually steerable such that the split rudder can assume any of different positions including a so-called closed position in which the rudder flaps are in surface contact with each other and so-called open positions in which the rudder flaps have particular opening angles with respect to each other, and the aircraft further comprises a control system configured to control steering of the rudder flaps of each of the rudders.

Such rudders provide, by their increased efficiency, an optimal ability to manoeuvre the space aircraft even at supersonic speeds, even though the aerodynamic profile of the space aircraft is otherwise optimised for subsonic speeds.

Preferably, each of said vertical tail units is arranged on the nacelle so that a medium plane of the fixed fin has an angle, of between 7° and 13°, and even more preferably substantially equal to 10°, with respect to a vertical plane of the nacelle, by being tilted towards the outside or the inside of the space aircraft. This angle reduces the acoustic and radiative interaction generated by the environment created by the rocket engine exhaust gases rearwardly of the space aircraft.

Moreover, advantageously, on each of said nacelles, the vertical tail unit and the horizontal tail unit are arranged such that a medium plane of the fixed fin of the vertical tail unit and a medium plane of the horizontal tail unit form an angle of substantially 90° with respect to each other.

The present invention also relates to a vehicle such as a space launch vehicle, sounding rocket or similar experimental vehicle, comprising a recoverable module, said recoverable module corresponding to a space aircraft such as the one described above.

### BRIEF DESCRIPTION OF THE FIGURES

The appended figures will make it clear how the invention can be made. In these figures, identical references refer to similar elements.

FIG. 1 is a schematic top view of a space aircraft according to one preferred embodiment of the invention.

FIG. 2 is a schematic perspective view of a space aircraft according to one preferred embodiment of the invention.

FIG. 3 is a partial side view of the fuselage of the space aircraft.

FIG. 4 is a partial perspective view of the fuselage of the space aircraft.

FIG. 5 is a partial schematic top view illustrating the position of shock waves in relation to the shape of the space aircraft, in accordance with preferred characteristics of the invention.

FIG. 6 is a partial top view of the rearwardly of the space aircraft, showing an expansion profile of the exhaust gases generated by a rocket engine.

FIG. 7 is a schematic view of the rearwardly of the space aircraft of FIGS. 1 and 2.

FIG. 8 is a perspective view of a nacelle of the space aircraft of FIGS. 1 and 2, showing a maximum steering angle of rudder flaps of a rudder.

FIG. 9 is a highly schematic perspective view of a nacelle part showing a rudder flap steering.

FIG. 10 is a schematic perspective view of a steering control system of rudder flaps of a rudder.

FIG. 11 is a schematic top view detailing the arrangement of the main equipment of a space aircraft according to one preferred embodiment of the invention.

### DETAILED DESCRIPTION

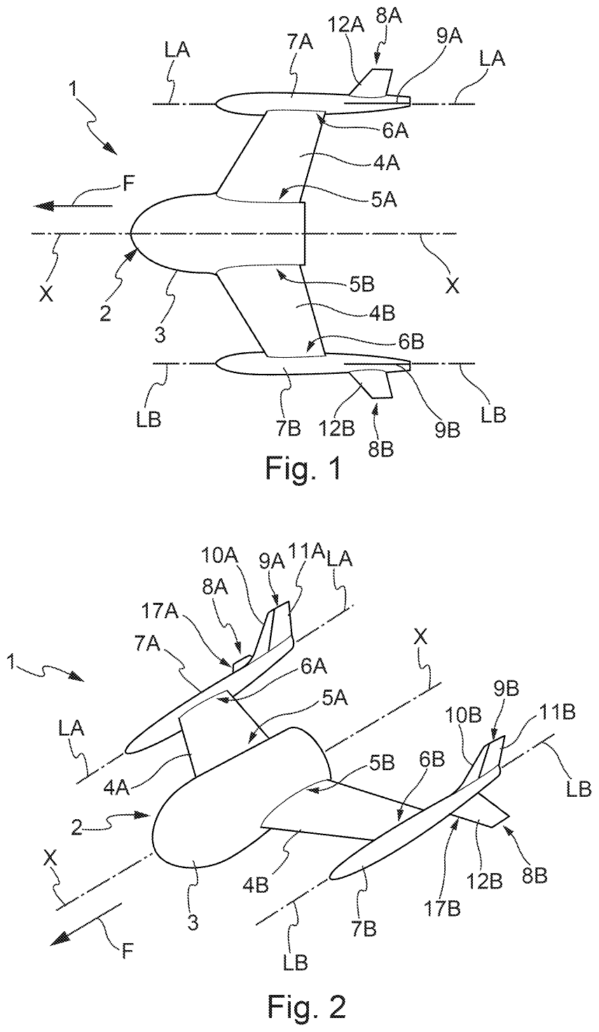

The space aircraft 1, schematically represented in one particular embodiment in FIGS. 1 and 2, is configured to be able to fly and this especially at high speeds, in particular in the context of atmospheric re-entry. Preferably, the space aircraft 1 is an unmanned space aircraft.

As a preferred application (considered in the following description), this space aircraft 1 corresponds to a flying module (or vehicle) which represents a recoverable part of a space launch vehicle, a sounding rocket or a similar experimental vehicle.

More generally, the space aircraft is to be recovered on Earth after its mission. This aircraft has therefore to be capable of performing an atmospheric re-entry, under the difficult conditions in which such re-entry is usually performed, as well as an approach to a landing strip and a landing on that landing strip. In this application, the space aircraft 1 comprises the components and systems specified below, which have a high cost, and whose reuse is very advantageous.

As represented in FIGS. 1 and 2, the space aircraft 1 comprises a main central body 2, with longitudinal axis X-X, forming a fuselage 3. The direction of flight F of the space aircraft 1 is illustrated by an arrow in FIGS. 1 and 2. In the context of the present invention, the terms “front” and “rear” are defined, respectively, with respect to the frontwardly and rearwardly of the space aircraft 1, the direction from rear to front being defined according to the direction F of flight of the space aircraft 1.

For ease and simplicity of the following description, similar elements arranged on both sides of the space aircraft 1 with respect to the fuselage 3 are identified by identical numerical references. However, depending on the side considered, a letter A (for elements on the right in the direction F of flight of the space aircraft 1) or a letter B (for elements on the left in the direction F of flight of the space aircraft 1) is added to these numerical references.

In the preferred embodiment represented in FIGS. 1 and 2, the space aircraft 1 is provided with two wings 4A and 4B attached, on either side of the longitudinal axis X-X, respectively by an end 5A, 5B, to the fuselage 3.

The space aircraft 1 is also provided, at each of the ends 6A and 6B (of the wings 4A and 4B) opposite to ends 5A and 5B, with an elongated nacelle 7A, 7B, in the general shape of an elongated ogive. The nacelle 7A has a longitudinal axis LA-LA, and the nacelle 7B has a longitudinal axis LB-LB. These longitudinal axes LA-LA and LB-LB are substantially parallel to the longitudinal axis X-X. The nacelles 7A and 7B are therefore arranged on either side of the fuselage 3, substantially parallel to the longitudinal direction of the fuselage 3. This arrangement of the nacelles 7A and 7B, laterally to the fuselage 3, is especially compatible with various launch vehicles or sounding rockets or similar experimental vehicles, and/or various rocket engines (including single or multiple rocket engines).

Furthermore, each of said nacelles 7A and 7B is provided with a horizontal tail unit 8A, 8B and a vertical tail unit 9A, 9B. Generally speaking, the tail units ensure, in particular, stability and control of the space aircraft about the yaw axis (for the vertical tail unit 9A, 9B) and about the pitch axis (for the horizontal tail unit 8A, 8B).

Each of the vertical tail units 9A and 9B has, as represented in FIG. 2, two parts, namely a fixed part called the fin 10A, 10B which is attached to the nacelle 7A, 7B, and a movable part called the rudder 11A, 11B, which is movably mounted onto the fin 10A, 10B. The function of the vertical tail units 9A, 9B is thus to ensure stability and control of the space aircraft 1 about the yaw axis. Their efficiency to this effect is optimal due to their eccentric positioning on the nacelles 7A, 7B, making it possible to increase the moment exerted around the centre of masses of the aircraft, in comparison with a central tail unit.

Additionally, each of said horizontal tail units 8A and 8B comprises, as represented in FIG. 1, a movable part 12A, 12B called elevator which is directly mounted onto the nacelle 7A, 7B. These horizontal tail units 8A and 8B thus contribute to the stability and control of the space aircraft 1 in pitch. In addition, as explained below, each of the elevators 12A, 12B is of the one-piece type, which provides the expected efficiency over the entire flight envelope to the horizontal tail units 8A and 8B.

The wings, as well as the nacelles and the elements they carry, are symmetrical with respect to a vertical plane of symmetry XZ (FIG. 4) of the space aircraft 1. By means especially of these characteristics, and as further specified below, the space aircraft 1 does not exhibit zero incidence lift during the climb phase.

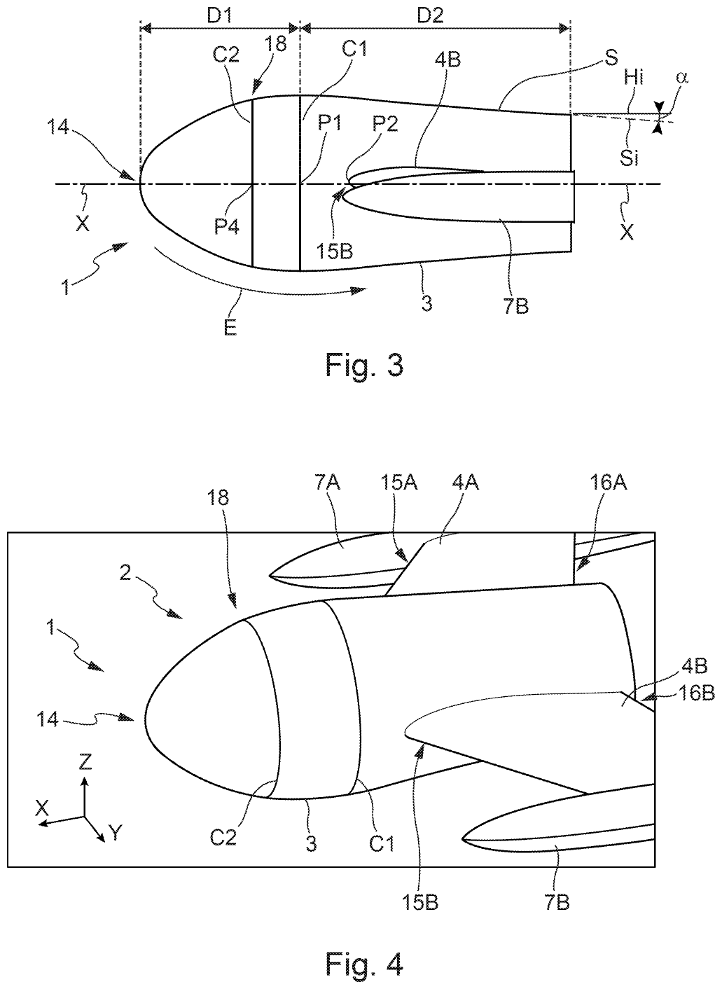

According to the invention, as especially represented in FIG. 3, the fuselage 3 of the space aircraft 1 has a transverse cross-section of variable size along the longitudinal axis X-X. The fuselage 3 is provided with a nose 14 frontwardly. From front (starting from the nose 14) to rear of the space aircraft 1, in the direction illustrated by an arrow E, along the longitudinal axis X-X, the size of the transverse cross-section of the fuselage 3 increases (over a distance D1) to a maximum transverse cross-section C1, that is, a transverse cross-section with a maximum surface area, and then it decreases (over a distance D2). A transverse cross-section corresponds to a section of the fuselage 3 in a plane YZ (FIG. 4) perpendicular to the longitudinal axis X-X.

Additionally, according to the invention, the maximum transverse cross-section C1 is located at a longitudinal position P1 along the longitudinal axis X-X. This longitudinal position P1 is located frontwardly of a longitudinal position P2 corresponding to the position of the leading edges 15A and 15B of the wings 4A and 4B at the fuselage 3, that is, at the wing roots, namely of the leading edge 15B of the wing 4B in the example of FIG. 3.

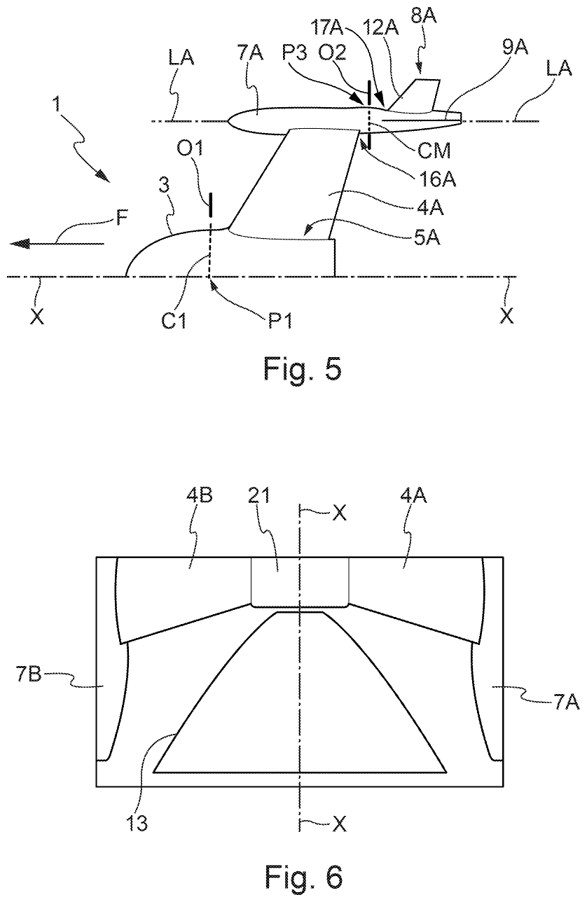

Thus, as the longitudinal position P1 of the maximum transverse cross-section C1 determines the longitudinal position of the transonic shock wave, by locating the maximum transverse cross-section C1 (longitudinal position P1) frontwardly of the leading edges 15A and 15B (longitudinal position P2) of the wings 4A and 4B, the first shock wave O1 is positioned in front of said leading edges 15A and 15B of the wings 4A and 4B in the transonic regime, as illustrated in FIG. 5, which makes it possible to avoid or at least limit a second shock wave in the middle of the wings 4A and 4B. This characteristic prevents the occurrence of significant flow detachment, and thus avoids a loss of longitudinal static stability.

Rearwardly of said longitudinal position P1 of maximum transverse cross-section C1, the fuselage 3 has an external surface S shaped such that it has a preferably variable angle α, with the longitudinal axis X-X. This local angle α is defined as the angle between the local tangent to the surface and the longitudinal axis X-X (viewed in FIG. 3 as an example between a line Si as an extension of the external surface S and a line Hi parallel to the longitudinal axis X-X) is less than or equal to 7°. This is to avoid as much as possible a sudden detachment of the flow on the fuselage 3.

The maximum transverse cross-section C1 may have a variable shape, which may or may not be circular.

Within the scope of the invention, a design strategy is implemented to verify an area rule. The purpose of applying this strategy is to increase the transverse cross-section of the fuselage 3 to obtain a maximum transverse cross-section C1 frontwardly of the leading edges 15A and 15B of the wings 4A and 4B, while keeping an external surface S limited to 7° to avoid local boundary layer detachment.

Once the shape of the fuselage 3 and the position of the wings 4A and 4B are set, the nacelles 7A and 7B are defined taking account of the following characteristics in accordance with the above mentioned design strategy.

Each of the nacelles 7A and 7B has a transverse cross-section of variable size along the respective longitudinal axes LA-LA and LB-LB of the nacelles 7A and 7B considered. From front to rear, along the longitudinal axis X-X, the size of the transverse cross-section of each of the nacelles 7A and 7B increases to a maximum transverse cross-section CM (FIG. 5) and then decreases. The maximum transverse cross-section CM is at a position P3 along said longitudinal axis LA-LA, LB-LB, which is located between the trailing edge 16A, 16B of the wing 4A, 4B at the nacelle 7A, 7B and the leading edge 17A, 17B of the horizontal tail unit 8A, 8B mounted onto the nacelle 7A, 7B, as represented for the nacelle 7A in FIG. 5. This allows the second transonic shock wave O2 to be positioned away from the control surfaces and lift surfaces.

The above characteristics therefore result in advantageous positioning of the transonic shock waves O1 and O2, close to the maximum transverse cross-sections C1 and CM, away from the control surfaces and lift surfaces, which thus remain as free as possible from any shock wave disturbance in the transonic flight regime.

Thus, the longitudinal position of the aerodynamic centre as a function of Mach number and angle of incidence throughout the mission's atmospheric re-entry flight corridor varies little and smoothly and continuously.

Besides, in one particular embodiment, the fuselage 3 has frontwardly of the maximum transverse cross-section C1, at a position P4 (FIG. 3), an interface zone 18 for the attachment of tanks of a space launch vehicle, sounding rocket or similar experimental vehicle when provided with the space aircraft 1. The transverse cross-section C2 at said interface zone 18 is advantageously circular. The course of the cross-section of the fuselage 3 along the axis X-X is such that the subsonic Mach zone remains frontwardly of this circular cross-section. This prevents the interface zone 18 from being impacted by significant transonic flows.

The space aircraft 1 allows the displacement of the aerodynamic centre to be controlled over the entire Mach number range of the space aircraft 1.

In terms of longitudinal aerodynamic characteristics, a smooth and continuous longitudinal aerodynamic centre displacement is achieved over the entire Mach number range encountered during atmospheric re-entry and return to the launch site, which may range from Mach 0.25 to Mach 25. This advantageous behaviour is achieved over the entire range of angles of attack required to perform the mission.

Additionally, with respect to the lateral aerodynamic characteristics, a smooth and continuous lateral aerodynamic centre displacement is achieved over the entire Mach number range encountered during atmospheric re-entry and return to the launch site. This advantageous behaviour is also achieved over the entire range of angles of attack and sideslip required to perform the mission.

It will be noted that:

a) the space aircraft 1 being statically longitudinally and laterally stable, during the re-entry phase, the flight control needs are minimised and part of the re-entry phase can be performed in a purely passive mode;

b) control of the initial re-entry attitude can be relaxed due to the inherent static stability, which will automatically reorient the attitude of the space aircraft with respect to the relative wind. This property provides additional robustness after the consumable part separation phase or, in other words, reduces the required exo-atmospheric attitude control needs; and

c) a small natural nose-up (without nose-up control) can be generated during re-entry. This characteristic provides robustness to the system and helps to reduce power requirement for the control means.

Besides, in one preferred embodiment, represented in FIG. 6, the lateral position of the nacelles 7A and 7B (on either side of the longitudinal axis X-X) and their longitudinal arrangement (rearwardly) are configured to be compatible with an expansion profile 13 of ejection gases, namely ejection gases generated by a rocket engine 21 rearwardly of the space aircraft 1. This is to be understood as meaning that the nacelles 7A and 7B are located outside an ejection gas flow in operation, or at least sufficiently away from the centre of the expansion profile 13 of ejection gases to withstand severe conditions prevailing in proximity to such ejection gases. Consequently, the structure of the space aircraft 1 and in particular the nacelles 7A and 7B are not subjected to and therefore not disturbed by said exhaust gases.

Furthermore, in one preferred embodiment, the horizontal tail unit 8A, 8B has a variable transverse cross-section along the axis X-X. Similarly, the vertical tail unit 9A, 9B also has a variable transverse cross-section along the axis X-X. Additionally, the maximum transverse cross-sections of the horizontal tail unit 8A, 8B and the vertical tail unit 9A, 9B are segregated longitudinally (along the axis X-X) and angularly to avoid as much as possible detrimental interactions during transonic flight regimes and thus to keep lateral and longitudinal control over the complete flight regime of the space aircraft 1.

To this end, the maximum transverse cross-section of the vertical tail unit 9A, 9B is placed rearwardly (in the direction of flight F of the space aircraft 1) of the maximum transverse cross-section of the horizontal tail unit 8A, 8B so that aerodynamic interference between the control surfaces can be minimised, in particular in said transonic flight regimes. This segregation is also efficient when the control surfaces of the vertical tail unit (rudder) and horizontal tail unit (elevator) are steered.

Furthermore, the vertical tail unit 9A, 9B is arranged above the horizontal plane of symmetry NA, NB of the space aircraft 1, passing through the wings 4A, 4B, as represented in FIG. 7, for favourable roll induced by sideslip stability.

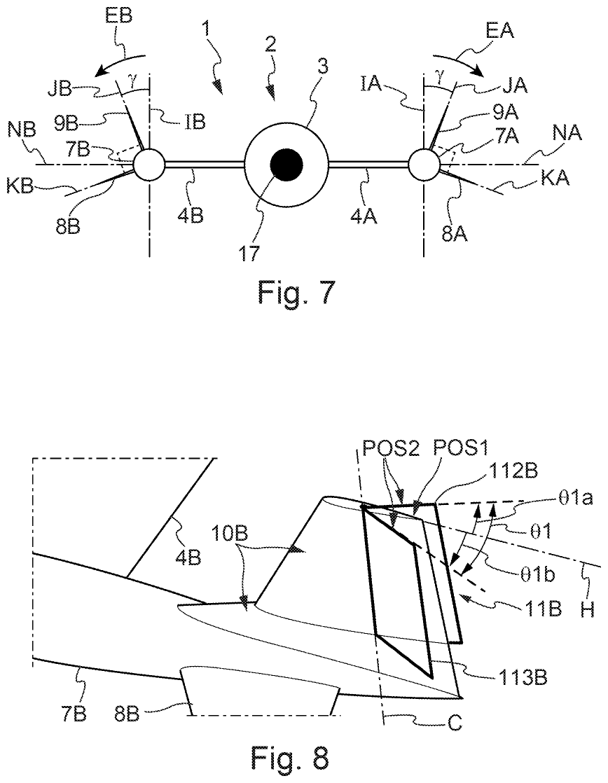

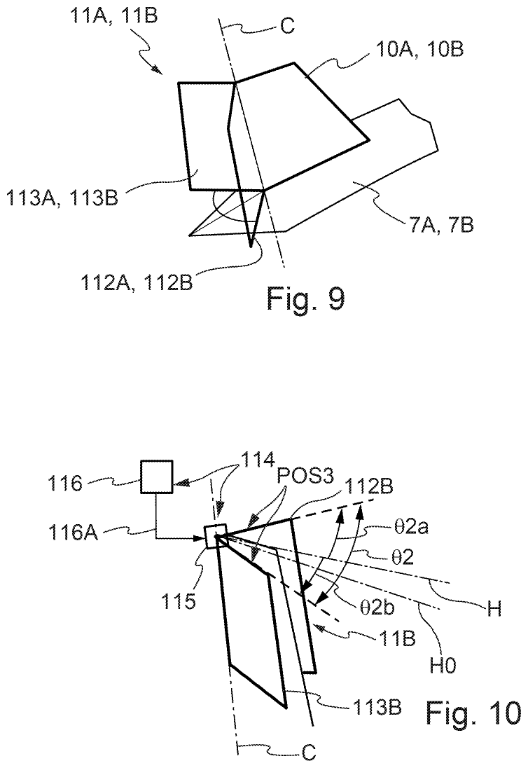

Besides, in one preferred embodiment, for each of said vertical tail units 9A and 9B, the rudder 11A, 11B is a so-called split rudder. Such a split rudder 11A, 11B comprises, as represented in FIGS. 8 and 9, two rudder flaps, namely a rudder flap 112A, 112B and a rudder flap 113A, 113B, which are individually movable and independent.

Each rudder 11A, 11B, namely the movable part of each of the vertical tail units 9A, 9B, which represents the aerodynamic control surface, thus corresponds to a split rudder with two independent degrees of freedom.

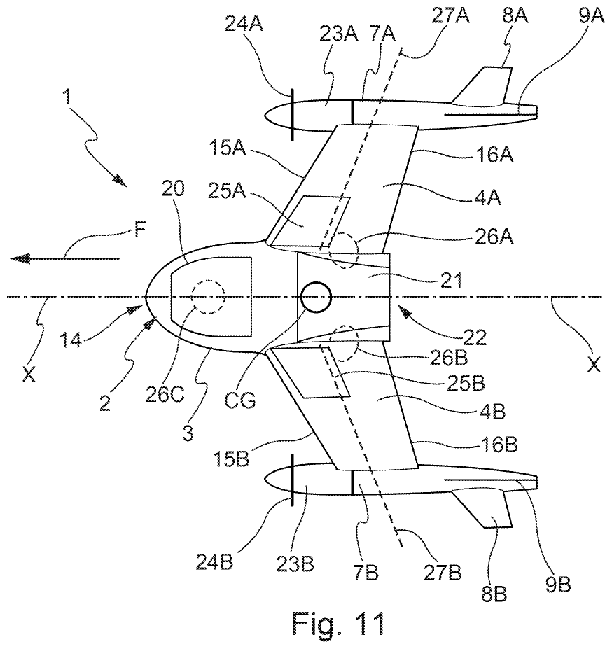

Each of the rudder flaps 112A, 112B, 113A, 113B of these split rudders 11A and 11B is capable of being individually steered about an axis C (FIGS. 8 to 10) so that each split rudder 11A, 11B can assume any of the following positions:
a closed position POS1 in which the rudder flaps 112B and 113B are in surface contact with each other, as represented in a thin line in FIG. 8 for rudder 11B; and
one of a plurality of open positions, in which the rudder flaps 112B and 113B have an opening angle θ (non-zero) with respect to each other, for example in the order of 20°, as represented by way of illustration in FIG. 8 in a thick line for a given opening position POS2 of opening angle θ1 and in FIG. 10 for a given opening position POS3 of opening angle θ2.

The steering operations of the two rudder flaps of a rudder (rudder flaps 112A and 113A of rudder 11A or rudder flaps 112B and 113B of rudder 11B) may be performed:
either symmetrically, with respect to a neutral position H, with angular deployments (of opposite directions) that are of the same value for both rudder flaps 112B and 113B, as illustrated in FIG. 8 where the angular deployment (or deflection) of the rudder flap 112B with respect to the neutral position H is illustrated by an arrow θ1a (showing the direction of deployment and the corresponding angle) and the angular deployment of the rudder flap 113B with respect to the neutral position H is illustrated by an arrow θ1b, the deflection angle θ1b being equal to the deflection angle θ1a and the opening angle θ1 satisfying the relationship θ1=θ1a+θ1b;
or asymmetrically, that is, one of the rudder flaps is steered more than the other from a neutral position H, as illustrated in FIG. 10 where the angular deployment of the rudder flap 112B with respect to the neutral position H is illustrated by an arrow θ2a and the angular deployment of the rudder flap 113B with respect to the neutral position H is illustrated by an arrow θ2b, the deflection angle θ2b being different from the deflection angle θ2a and the opening angle θ2 satisfying the relationship θ2=θ2a+θ2b.

Furthermore, the neutral position can be changed, for example from a position H (corresponds to the position of the medium plane of the fixed fin of the corresponding vertical tail unit) to a position HO as illustrated in FIG. 10.

The aircraft 1 also includes a control system 114 configured to control steering of the rudder flaps 112A, 112B, 113A and 113B of each of the rudders 11A and 11B.

This control system 114 comprises, as schematically shown in FIG. 10 for rudder 11B, an actuation system 115 for pivoting the rudder flaps, and a control unit 116 for controlling this actuation system 115 (via a link 116A).

Generally speaking, such split rudders provide, by their increased efficiency, an optimal ability to manoeuvre the space aircraft even at supersonic speeds, even though the aerodynamic profile of the space aircraft is preferably optimised for subsonic speeds in order especially to allow a safe landing.

The use of such split rudders also allows the space aircraft to be without a central tail unit rearwardly of the fuselage, which is especially advantageous in cases where a rocket engine is arranged rearwardly of the fuselage, as will become clearer in the following.

Furthermore, in one preferred embodiment, each of the vertical tail units 9A, 9B is arranged on the nacelle 7A, 7B such that a medium plane JA, JB of the fin of the vertical tail unit 9A, 9B has a non-zero angle γ with respect to a vertical plane IA, IB of the nacelle 7A, 7B, by being tilted towards the outside of the space aircraft 1, in a direction from the nacelle 7A, 7B towards an upper end of the fixed fin 10A, 10B, as illustrated by an arrow EA, EB in FIG. 7. This angle γ (ranging, for example, from 7° to 13°) is preferably in the order of 10°. This angle γ (of relatively small value) makes it possible to reduce acoustic and radiative interaction between the nacelles, due in particular to exhaust gases rearwardly of the space aircraft 1, generated by the rocket engine 21 (FIG. 6).

In one preferred embodiment, on each of said nacelles 7A and 7B, the vertical tail unit 9A, 9B and the horizontal tail unit 8A, 8B are arranged so that the medium plane JA, JB of the fin 10A, 10B and a medium plane KA, KB of the horizontal tail unit 8A, 8B form an angle of substantially 90° with respect to each other, as represented in FIG. 7. Therefore, with the aforementioned arrangement of the vertical tail unit 9A, 9B, each horizontal tail unit 8A, 8B adopts, for an angular segregation close to 90° with respect to the vertical tail unit 9A, 9B, a downward angle with respect to the plane NA, NB of the wings 4A and 4B.

The planform of the wings 4A, 4B is chosen as simple as possible, taking production and thermal protection considerations into account. Additionally, as represented in FIG. 11, the wings 4A and 4B comprise leading edges 15A and 15B and trailing edges 16A and 16B which are rectilinear. A moderate sweep with an angle of 30° (at 25% of the chord) is adopted to minimise the loss of subsonic lift due to sweep.

Besides, the space aircraft 1 is provided with an assembly 20 comprising avionic systems as well as a pressurisation system for the rocket engine propulsion system. This assembly 20 is arranged frontwardly of the nose 14 of the space aircraft 1, as represented in FIG. 11.

This frontward position contributes to the forward displacement of the centre of gravity CG of the space aircraft 1 and promotes:
increasing the aerodynamic leverage arms of the horizontal and vertical tail units; and
access to the elements of this assembly 20 frontwardly of the fuselage 3, particularly for maintenance.

The shape of the nose 14 is designed to dissipate energy during atmospheric re-entry. To this end, a rounded (blunt) nose 14 is provided to generate a relatively high hypersonic/supersonic aerodynamic drag.

Besides, the space aircraft 1 comprises a propulsion assembly such as the rocket engine 21 (FIG. 11), to perform the launch of the space launch vehicle, or at least assist in the launch of said space launch vehicle. The rocket engine 21 is arranged at the rear end 22 of the fuselage 3. In one particular embodiment (not shown), the space aircraft 1 may comprise a plurality of rocket engines.

The space aircraft 1 also comprises conventional means for generating its return flight, and in particular an aeronautical propulsion system provided with aeronautical propulsion units 23A and 23B of any type, for example a propeller-driven turboprop engine whose propellers 24A and 24B are schematically shown in FIG. 11. The space aircraft 1 further comprises usual control and piloting means which are not described further and which allow the space aircraft 1 especially to implement atmospheric re-entry and to carry out a recovery manoeuvre followed by a cruise flight until a landing on a runway.

As represented in FIG. 11, the aeronautical propulsion units 23A and 23B are arranged in the nacelles 7A and 7B, frontwardly of said nacelles 7A and 7B.

As the aeronautical propulsion units 23A and 23B of the aeronautical propulsion system are arranged frontwardly of the nacelles 7A and 7B, it is possible to:
move the centre of gravity CG of the space aircraft 1 forward;
move the aeronautical propulsion system as far as possible from the exhaust gases of the rocket engine 21, as well as from all the space systems contained in the fuselage 3;
provide favourable characteristics to reduce aerodynamic (aeroelastic) flapping under some critical flight conditions (in Mach number and dynamic pressure);
reduce the bending moment at the wing roots during nose-up manoeuvres, in particular during the recovery phase implemented after atmospheric re-entry; and
ensure optimal operation of the aeronautical propulsion units 23A and 23B which thus benefit from undisturbed flow upstream of the propellers and air intakes.

Besides, the space aircraft 1 also comprises fuel tanks 25A and 25B for the aeronautical propulsion units 23A and 23B of the aeronautical propulsion system. These fuel tanks 25A and 25B are arranged in the wings 4A and 4B of the space aircraft 1. Preferably, the fuel tanks 25A and 25B are arranged:
close to the fuselage 3 to contribute to the forward positioning of the centre of gravity CG, taking into account the sweep of the wings 4A and 4B; and
in proximity to the centre of gravity CG, in order to minimise displacement of the centre of gravity CG when consuming the fuel (contained in said fuel tanks 25A and 25B) during the subsonic re-entry cruise flight.

In this way, a proper longitudinal centring of the space aircraft 1 is achieved, substantially unchanged during the flight of the mission. In particular, when all fuel is consumed, the position of the centre of gravity CG is suitable for longitudinal adjustment and lateral control, which are required for a landing or go-around manoeuvre during a landing phase of the space aircraft 1.

The arrangement of the fuel tanks 25A and 25B, each of which can hold for example about 300 kg, in the wing roots between the two wing spars as close as possible to the centre of gravity CG of the space aircraft 1 minimises displacement of the centre of gravity CG when consuming fuel. However, a slight rearward displacement of the centre of gravity CG under landing conditions is generated to minimise longitudinal static margin during the touchdown flare.

Besides, to be able to perform landing, the space aircraft 1 is provided with a set of deployable landing gears 26A, 26B and 26C. The landing gears 26A and 26B are arranged close to the fuselage 3 of the space aircraft 1, taking account of the volumes available for their arrangement and the position of the centre of gravity on landing. The nose gear 26C is housed in the fuselage as far forward as possible on the axis X-X to:
in the retracted position, contribute to the forward positioning of the centre of gravity CG; and
in the deployed position, ensure a distribution of support between the landing gears 26A, 26B and 26C, in accordance with standard practice in the aeronautical field.

The space aircraft 1 is compatible with the arrangement in the fairings close to the ends 5A and 5B for the landing gears 26A and 26B and in the fuselage for the landing gear 26C of a set of in particular simplified landing gears, comprising no brake, no hydraulic system and no front wheel guidance.

The space aircraft 1 thus has a unique and advantageous architecture combining the aforementioned characteristics and having an overall coherence to implement high level functions.

The advantages of said space aircraft 1, as described above, are specified below in more detail.

The space aircraft 1 is compatible with the expansion of exhaust gases of the rocket engine 21 during the climb, as indicated above with reference to FIG. 6. To this end, its elements and systems are located outside the expansion profile 13 of the exhaust gases of the rocket engine 21 during the climb. This ensures geometric exhaust compatibility with a single rocket engine 21. This geometric construction principle can be similarly achieved for any type of rocket engine as well as for multi-rocket engine launcher configurations.

Furthermore, the space aircraft 1 may have additional characteristics that contribute to minimising thermal loads. In particular, in one particular embodiment, the space aircraft 1 includes thermal protection on the thick trailing edges of the wings 4A and 4B and the vertical tail units 9A and 9B.

Furthermore, in one particular embodiment, the space aircraft 1 may comprise an additional local protection (not shown) on each vertical tail unit 9A, 9B. Preferably, this local protection comprises a protective layer, which may be ejectable upon shutting down the rocket engine 21.

Besides, as indicated above, an appropriate and advantageous mass distribution is implemented on the space aircraft 1 in order to control the position of its centre of gravity CG (FIG. 11) and the aeroelasticity during the whole mission.

To do so, the main masses of the space aircraft 1 systems are arranged at the most forward positions in order to obtain an advantageous position of the centre of gravity CG and to control this position from the beginning of atmospheric re-entry until landing.

In one preferred embodiment, the mass of each aeronautical propulsion unit 23A, 23B is arranged frontwardly of a twist line 27A-27B of the corresponding wing 4A, 4B, as represented in FIG. 11, thereby minimising the tendency to flutter, particularly in the transonic flight regime.

Furthermore, the arrangement of each aeronautical propulsion unit 23A, 23B in the nacelle 7A, 7B at the wing end allows minimising the bending moment of the wings 4A, 4B during nose-up manoeuvres, in particular upon re-entry.

Furthermore, the surface area of each wing 4A, 4B is chosen to be compatible with the re-entry, cruise flight and landing phases at approximately 250 kg/m² wing load.

Furthermore, as represented in FIG. 11, a separation (or distance) between the main systems in the space aircraft 1 is provided.

In particular, the rocket engine 21, the aeronautical propulsion units 23A and 23B, and the control devices are decoupled. In this way, a suitable distribution of the main systems can be achieved to avoid negative interactions between them. In particular, the space systems are segregated from the avionic systems, and the rocket engine 21 is protected rearwardly of the space aircraft 1 during the re-entry phase. In addition, the avionic and pressurisation systems 20 are arranged frontwardly of the space aircraft 1 with interfaces with the fuel tanks 25A and 25B.

Besides, the general shape of the space aircraft 1 allows for zero lift at zero angle of incidence during the climb phase. To do so, the following is provided:
an axisymmetric fuselage 3, leading to a symmetric fuselage with respect to the plane XY;
a mid-plane position of the wings 4A and 4B;
nacelles 7A, 7B for receiving the aeronautical propulsion units 23A, 23B which are arranged in the plane XY of the wings 4A and 4B (FIG. 4); and
the vertical and horizontal tail units are constructed and arranged to minimise drag and disturbing moments during the climb phase.

In addition, as mentioned above, each vertical tail unit 9A, 9B is tilted in the order of 10° (FIG. 7) in order to reduce acoustic and thermal interaction with the exhaust gases of the rocket engine 21.

On the other hand, the re-entry phase does not influence the choice of the front shape of the space aircraft 1.

Besides, in order to participate in the longitudinal and lateral stability of the space aircraft 1, additional characteristics are provided in addition to the aforementioned characteristics. In particular:
the planform of the wings 4A and 4B limits the tendency to transonic nose-up, by providing an appropriate wing aspect ratio (ratio of the square of the wing span to the wing surface area), with a wing sweep of 30° to 25% of the aerodynamic mean chord;
a thick trailing edge on the profile of each wing 4A, 4B makes it possible to increase robustness of the profile at the transonic boundary layer;
the fairings of the nacelles 7A and 7B and the wings 4A and 4B are configured to locally increase robustness to transonic flow separation; and
ailerons on the wings are of the split type, each aileron comprising two independent movable elements, each of said movable elements being capable of being individually steered, which allows both an increase in longitudinal stability and a roll control capability.

Besides, appropriate deflections of the control surfaces, including possible transfers of functionalities between the wings 4A and 4B and the horizontal tail units 8A and 8B, can be implemented to remedy occasional aeroelastic problems in the transonic flight regime. As an example, a deflection of about 10° of an outer aileron of each wing 4A, 4B during the transonic phase can be contemplated.

Furthermore, for each horizontal tail unit 8A, 8B, the following characteristics are preferably provided:
the elevator 12A, 12B is of the one-piece type for appropriate supersonic, transonic and subsonic efficiency;
the hinge line is advantageously placed at approximately 50% of the chord to minimise hinge moment; and
the profile of each horizontal tail unit 8A, 8B is suitable for transonic and subsonic flight regimes.

Furthermore, the horizontal tail units 8A and 8B can also be used for roll control of the space aircraft 1.

Besides, the space aircraft 1 has enhanced aerodynamic performance, including efficient supersonic deceleration during atmospheric re-entry, efficient recovery manoeuvre in the transonic flight regime, and efficient subsonic cruise flight during return to the launch site.

The following elements contribute to efficient deceleration (increase in supersonic ballistic coefficient) during re-entry (at low angle of incidence):
the blunt (rounded) nose 14 at fuselage 3 with a course along the longitudinal axis of fuselage 3 such that the subsonic Mach zone remains frontwardly of the cross-section C2 (FIG. 3). This prevents the interface zone 18 from being impacted by significant transonic flows;
a blunt (rounded) nose at each nacelle 7A, 7B, which is compatible with the arrangement of the aeronautical propulsion unit 23A, 23B; and
a thick leading edge 15A, 15B at each wing 4A, 4B, which locally reduces thermal flows and increases supersonic drag, particularly in the shock/shock interaction area in proximity to the nacelle 7A, 7B.

Besides, the following elements contribute to an efficient nose-up manoeuvre in the transonic flight regime (at about Mach 0.8):
the one-piece construction of each horizontal tail unit 8A, 8B; and
the horizontal segregation between the vertical tail unit 9A, 9B and the horizontal tail unit 8A, 8B.

Furthermore, the space aircraft 1 has a compact configuration with a short, blunt fuselage and a wing span of the same order of magnitude, allowing for efficient subsonic cruise flight on return to the launch site.

More particularly:
the wing aspect ratio is more favourable, resulting in a better subsonic lift-to-drag ratio (fineness ratio). This directly and specifically reduces the power and mass requirements of the aeronautical propulsion unit 23A, 23B as well as the fuel consumption for the aeronautical propulsion phase and also reduces the rate of glide descent, allowing time to implement the ignition (or start) sequence of the aeronautical propulsion system, authorising a second attempt to restart said aeronautical propulsion system in the case of an unsuccessful first attempt;
the use of thick profiles with a relative thickness of more than 10% is also consistent with efficient subsonic cruise flight and approach and landing without the use of movable high lift generating devices at the leading and/or trailing edge;
the efficiency of the horizontal tail unit 8A, 8B in achieving the maximum lift coefficient on landing flare;
roll control via wing ailerons (not shown) in the subsonic regime; and
wing load compatible with a usual three-wheel landing gear.

Besides, the arrangement of the control surfaces downstream of the aeronautical propulsion units 23A and 23B provides additional subsonic performance during the flight phase (propelled with the propeller aeronautical propulsion units), with appropriate directions of rotation of the propellers, as specified below.

Besides, the space aircraft 1 comprises an advantageous integration of the aeronautical propulsion system. This advantageous aerodynamic propulsion is based on aeronautical propulsion units 23A, 23B each comprising a propeller 24A, 24B, which is foldable and forms part of a turboprop engine.

The integration of the foldable propeller 24A, 24B (of the propeller turboprop) into the nose of the nacelle 7A, 7B allows for low drag during the climb, a protected propeller and low fuel consumption during the flight (propelled by the aeronautical propulsion units 23A and 23B) back to the launch site.

The arrangement of the aeronautical propulsion units 23A and 23B frontwardly of the nacelles 7A and 7B also has the following advantages:
when the aeronautical propulsion units 23A and 23B comprise counter-rotating propellers 24A and 24B:
a significant increase in lift can be generated on the wings 4A and 4B;
an increased efficiency is available on the horizontal tail units 8A and 8B, requiring reduced trim (or balancing) deflections;
such a configuration, in addition to a positive contribution to the lift-to-drag ratio, also generates a proper symmetrical flow around the space aircraft, which further reduces lateral balancing requirements on the vertical tail units 9A and 9B; and
where aeronautical propulsion units 23A and 23B do not have counter-rotating propellers 24A and 24B, local and asymmetric aerodynamic control surface deflections can be implemented to achieve longitudinally and laterally balanced flight.

The arrangement of the aeronautical propulsion units 23A and 23B in the nacelles 7A and 7B, may comprise a fairing (not shown) when the corresponding propeller 24A, 24B is deployed. This fairing:
reduces aerodynamic losses on the hub of the propeller 24A, 24B;
positively contributes to the aerodynamic thrust of the propeller 24A, 24B; and
generates a proper air flow over the propeller blades 24A, 24B.

Besides, the advantageous distribution of mass on the space aircraft 1 reduces the bending and twisting moment at the ends 5A and 5B during the re-entry recovery manoeuvre, due to the fact that the nacelles 7A and 7B (carrying the aeronautical propulsion units 23A and 23B) are located at the wing ends 4A and 4B.

Furthermore, the advantageous weight distribution on the space aircraft 1, due to the fact that the nacelles 7A and 7B (carrying the aeronautical propulsion units 23A and 23B) are located at the ends of the wings 4A and 4B, with the aeronautical propulsion units 23A and 23B frontwardly of the twist line 27A, 27B of the wings 4A and 4B, generates a reduction of the tendency to aeroelastic flutter of the wings 4A and 4B.

What is claimed is:

1. A space aircraft, comprising a fuselage and two wings arranged on either side of said fuselage, said wings being arranged so that their respective leading edges are located at a position called first longitudinal position along a longitudinal axis of said fuselage, the space aircraft also comprising two nacelles arranged at the ends of the wings, these nacelles each carrying a horizontal tail unit and a vertical tail unit,
wherein said fuselage has a transverse cross-section of variable size along the longitudinal axis of said fuselage, and wherein, from front to rear of the space aircraft, along the longitudinal axis, the size of the transverse cross-section of the fuselage increases to a maximum transverse cross-section and then decreases and in that the maximum transverse cross-section is at a position called second longitudinal position along said longitudinal axis, this second longitudinal position being located frontwardly of said first longitudinal position.

2. The space aircraft according to claim 1,
wherein, rearwardly of said second longitudinal position of the maximum transverse cross-section, the fuselage has an external surface shaped such that it has an angle (with the longitudinal axis which is less than or equal to 7°.

3. The space aircraft according to claim 1,
wherein each of said nacelles has a transverse cross-section of variable size along the longitudinal axis of said fuselage, wherein from front to rear along the longitudinal axis, the size of the transverse cross-section of each of said nacelles increases to a maximum transverse cross-section and then decreases, and wherein the maximum transverse cross-section is at a position along said longitudinal axis, which is located between the trailing edge of the wing and the leading edge of the horizontal tail unit of the considered nacelle.

4. The space aircraft according to claim 1,
wherein on each of said nacelles, the vertical tail unit and the horizontal tail unit are arranged on the considered nacelle such that a maximum transverse cross-section of the vertical tail unit is located, longitudinally, rearwardly of a maximum transverse cross-section of the horizontal tail unit.

5. The space aircraft according to claim 1,
wherein, on each of said nacelles, the vertical tail unit and the horizontal tail unit are arranged such that a medium plane of the vertical tail unit and a medium plane of the horizontal tail unit form an angle of substantially 90° with respect to each other.

6. The space aircraft according to claim 1,
comprising at least some of the following systems:
avionic systems and a pressurisation system arranged in a nose of the space aircraft;
aeronautical propulsion units arranged in the nacelles, frontwardly of said nacelles;
at least one rocket engine arranged rearwardly of the space aircraft; and
fuel tanks arranged in the wings of the space aircraft in proximity to the fuselage.

7. The space aircraft according to claim 6,
wherein the aeronautical propulsion units are arranged frontwardly of a twist line of the wings of the space aircraft.

8. The space aircraft according to claim 1,
wherein the spanwise positions of the nacelles are located beyond an expansion profile of the exhaust gases of a, or the, rocket engine of the space aircraft.

9. The space aircraft according to claim 1,
wherein the fuselage is axisymmetric.

10. The space aircraft according to claim 1,
wherein the wings are positioned at mid-plane.

11. The space aircraft according to claim 1,
wherein the nacelles are arranged in a medium plane of the wings.

12. The space aircraft according to claim 1, wherein each of said vertical tail units comprises a fixed fin and a rudder, wherein the rudder is a split type rudder comprising two independent movable rudder flaps, each of said rudder flaps being individually steerable so that the split rudder can assume any of different positions including a so-called closed position in which the rudder flaps are in surface contact with each other and so-called open positions in which the rudder flaps have particular opening angles with respect to each other, and the aircraft further comprising a control system configured to control steering of the rudder flaps of each of the rudders.

13. The space aircraft according to claim 12, wherein each of said vertical tail units is arranged on the corresponding nacelle so that a medium plane of the corresponding fixed fin has an angle of between 7° and 13°, with respect to a vertical plane of the nacelle, by being tilted outwardly of the aircraft in a direction from the nacelle towards an upper end of the fixed fin.

14. A vehicle, in particular a space launch vehicle, sounding rocket or similar experimental vehicle, comprising a recoverable module,
wherein said recoverable module is a space aircraft according to claim 1.
